(19) United States
(12) Patent Application Publication
(10) Pub. No.: US 2007/0061541 A1
(43) Pub. Date: Mar. 15, 2007

(54) SEARCHING METHOD AND COMPUTER SYSTEM FOR DETERMINING A FUNCTION ASSOCIATED WITH A MEMORY BLOCK

(76) Inventor: ANG-SHENG LIN, Chang-Hua Hsien (TW)

Correspondence Address: NORTH AMERICA INTELLECTUAL PROPERTY CORPORATION, P.O. BOX 506, MERRIFIELD, VA, 22116, US

(21) Appl. No.: 11/462,052

(22) Filed: Aug. 3, 2006

(30) Foreign Application Priority Data
Aug. 4, 2005 (TW) 094126563

(51) Int. Cl. G06F 12/00

(52) U.S. Cl. 711/170; 711/202

(57) ABSTRACT

A searching method for determining a function associated with a memory block of a memory of a computer system and the computer system thereof are disclosed. A first function execution code executed by the computer system calls a second function execution code to require the computer system to allocate a first memory block to the first function execution code. A symbol mapping table (i.e., a linker map) stores a symbol address corresponding to the first function execution code. The searching method includes storing a return address of the second function execution code into a predetermined memory block of the memory, reading the return address from the predetermined memory block, and determining that the first memory block has been allocated to the first function execution code according to the return address and the symbol address stored in the symbol mapping table.

### BACKGROUND OF THE INVENTION

1. Field of the Invention

The present invention relates to a searching method for determining a function associated with a memory block and a computer system thereof, and more specifically, to a searching method and a computer system for determining a function associated with a memory block according to a return address stored in a header of the memory block.

2. Description of the Prior Art

In a computer system, it is fundamental to provide a system service for dynamically allocating a memory block to a function. Each function can require the computer system to dynamically allocate a memory block, and later that same function returns the allocated memory block back to the computer system after it has been determined that the function no longer requires the allocated memory. In this way, the goal of sharing the memory resource can be achieved. However, if it is determined that the allocated memory block will no longer be utilized by the function but is not returned to the computer system, the allocated memory block that will not be utilized again by the function can not be re-allocated by the computer system for utilization by a different function. This results in a situation in which the available memory resources tend to decrease over time. This phenomenon is generally referred to as a memory leak. A memory leak results in the lack of memory resources that can be utilized by the computer system. If the memory leak is not serious, perhaps a slow memory leak, it causes the performance of the computer system to be reduced. If the situation is serious, perhaps a very fast memory leak, it may cause the computer system to crash. A memory leak is a considerably serious problem. When the computer system detects that there is insufficient available memory space, it is necessary and important for the computer system to further check to determine if the insufficiently availability of memory space resulted from a memory leak. Furthermore, it is critical to realize what has caused the memory leak. An embodiment is provided in the following paragraph for describing how to resolve the aforementioned question by relying on a prior art.

Please refer to FIG. 1. FIG. 1 is a functional block diagram of a computer system 10 according to a prior art. The computer system 10 comprises a microprocessor 12, a flash memory 14, a random access memory (RAM) 16, and a buffer memory 18. The operation of the computer system 10 comprises the microprocessor 12 accessing data stored in the flash memory 14, the RAM 16 or the buffer memory 18, and the process of executing necessary operations. The flash memory 14 is a non-volatile memory storing a source code FS1 of a first function F1, a source code FS2 of a second function F2, and two pre-process directives, “_{——}FILE_{——}” and “_{——}LINE_{——}” corresponding to the first function F1. Functions of the two pre-process directives will be described in the following paragraph. The RAM 16 is a volatile memory comprising a plurality of memory blocks 16a, 16b, and 16c. The memory block 16a contains a header 16ah, the memory block 16b contains a header 16bh, and the memory block 16c contains a header 16ch. Additionally, in the computer system 10, the buffer memory 18 is utilized for storing an execution code that has been generated by the microprocessor 12 for compiling a function.

Please refer to FIG. 1 and FIG. 2. FIG. 2 is a diagram of the first function F1 shown in FIG. 1 calling (i.e., invoking) the second function F2 according to the prior art. The microprocessor 12 compiles a program containing the first function F1 and the second function F2. During the compilation of the program, the microprocessor 12 obtains the instructions that the content of the line number L1 of the first function F1 is to call the second function F2. At this time, according to the prior art, the micro-processor 12 records the function name (i.e., F1) of the first function F1 in the pre-process directive _{——}FILE_{——}, and records the line number L1 in the pre-process directive _{——}LINE_{——}. After the program has been compiled, the micro-processor 12 generates a first function execution code FE1 corresponding to the first function F1, and a second function execution code FE2 corresponding to the second function F2. Please note that the first function execution code FE1 and the second function execution code FE2 are both stored in the buffer memory 18.

In the present embodiment, the first function F1 calls the second function F2 to instruct the computer system 10 to allocate a certain memory block to the first function F1. After the program has been compiled, it enters a program run time stage. When the computer system 10 executes the first function execution code FE1, specifically, FE1's certain part that is corresponding to the line number L1, the program counter branches to the address of the second function execution code FE2. The computer system 10 then starts to execute the second function execution code FE2 from the beginning of the second function F2. Assume now the second function F2 requires the computer system 10 to allocate the memory block 16b to the first function F1. At this time, the computer system 10 copies the memory allocation information stored in the header of the memory block 16b, wherein the memory allocation information contains the function name (i.e., F1) of the first function F1 and the line number L1, respectively stored in the pre-process directives _{——}FILE_{——} and _{——}LINE_{——}. As is well known in the art, the data type of the data stored in the pre-process directive _{——}FILE_{——} is the character data type. Therefore, as the number of characters in the function name increases, the space occupied by the pre-process directive _{——}FILE_{——} increases. The data type of the line number stored in the pre-process directive _{——}LINE_{——} is the integer data type. This integer data type usually occupies 4 bytes. After the computer system 10 finishes executing the second function execution code FE2, the execution point (i.e., the program counter) branches back to the first function F1. The computer system 10 then executes the line L2 (the line next to and following the line L1) of the first function F1, which means that the computer system 10 starts to execute the first function execution code FE1, specifically, FE1's certain part that is corresponding to the line number L2.

When an engineer or a programmer discover there may be a memory leak, the engineer or programmer can check the header of the memory block 16b to obtain the allocation related information of the memory block 16b. Note that the memory block 16b is allocated to the first function F1 by the computer system 10. That means, according to the prior art, when a memory leak occurs and the engineer needs to find an allocated memory block that should be returned to the computer system 10 but in fact it has not been returned, the engineer can obtain allocation related information of all memory blocks to find which the allocated memory block is and which function the allocated memory block is allocated to by the computer system 10. In this way, the reason of the memory leak problem may be found. However, during the program compilation time, the prior art method needs to occupy some space of the non-volatile memory to store the memory allocation information—for the data of the pre-process directives _{——}FILE_{——} and the _{——}LINE_{——}. Also, during the program execution time, the memory allocation information is copied to the random access memory (RAM). Hence, the expended time and the memory space cost are increased and the overhead of the computer system is raised accordingly.

### SUMMARY OF THE INVENTION

One of the objectives of the claimed invention is therefore to provide a searching method for determining a function associated with a memory block according to a return address stored in a header of the memory block, in order to resolve the above-mentioned problem.

According to the claimed invention, a searching method is disclosed. The searching method is utilized for determining a function associated with a memory block of a memory of a computer system. The memory comprises a plurality of memory blocks and stores a first function execution code, a second function execution code, and a symbol mapping table (i.e., a linker map). The first function execution code executed by the computer system calls the second function execution code to require the computer system to allocate a first memory block to the first function execution code. The symbol mapping table stores a symbol address corresponding to the first function execution code. The searching method comprises: storing a return address of the second function execution code into a predetermined memory block of the memory, reading the return address from the predetermined memory block, and determining that the first memory block has been allocated to the first function execution code according to the return address and the symbol address stored in the symbol mapping table.

In addition, the claimed invention provides a computer system. The computer system comprises: a memory comprising a plurality of memory blocks for storing a first function execution code, a second function execution code and a symbol mapping table (i.e., a linker map), wherein the symbol mapping table stores a symbol address corresponding to the first function execution code; and a computation unit, coupled to the memory, for executing the first function execution code and the second function execution code, wherein the first function execution code calls the second function execution code to require the computer system to allocate a first memory block to the first function execution code and stores a return address of the second function execution code into a predetermined memory block of the memory, and the computation unit reads the return address from the predetermined memory block and determines that the first memory block has been allocated to the first function execution code according to the return address and the symbol address stored in the symbol mapping table.

One advantage according to the claimed invention is that there is definitely no need to occupy any additional non-volatile memory space. In contrast to the prior art memory allocation information, the claimed invention memory allocation information stored in a header of an allocated memory block is only a return address, and it only requires 4 bytes of space in the header to store the return address. In this way, it is easy to precisely and quickly find a function associated with the allocated memory block. Hence, the claimed invention searching method provides the computer system with a reduced system overhead, and reduces the expended time and required memory space to further increase the execution performance and the execution speed of the computer system.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a computer system according to a prior art.

FIG. 2 is a diagram of the first function shown in FIG. 1 calling the second function according to the prior art.

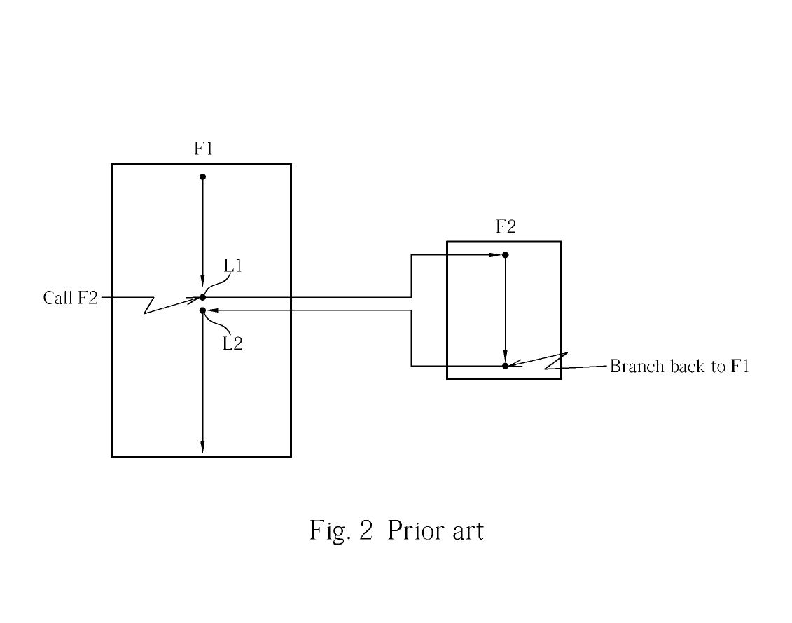

FIG. 3 is a functional block diagram of a computer system according to the present invention.

FIG. 4 is a flowchart of a first stage of a searching method that determines a function associated with a memory block.

FIG. 5 is a flowchart of a second stage of a searching method that determines a function associated with a memory block.

### DETAILED DESCRIPTION

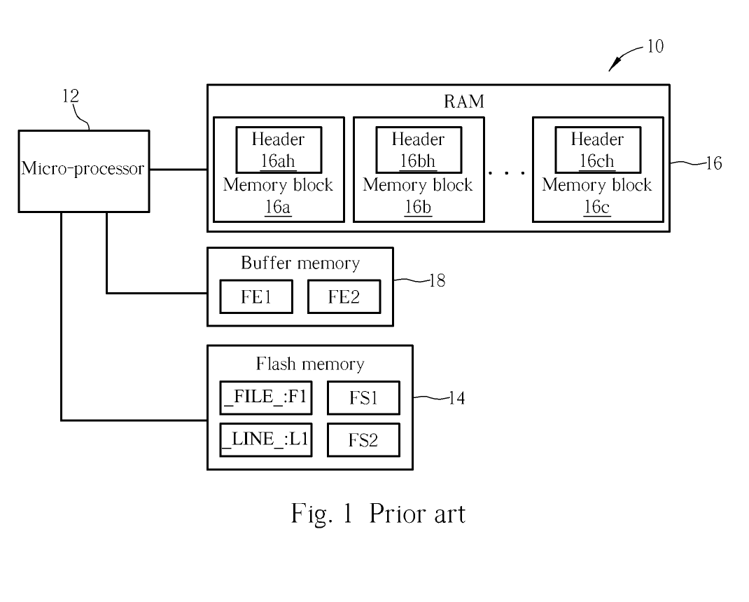

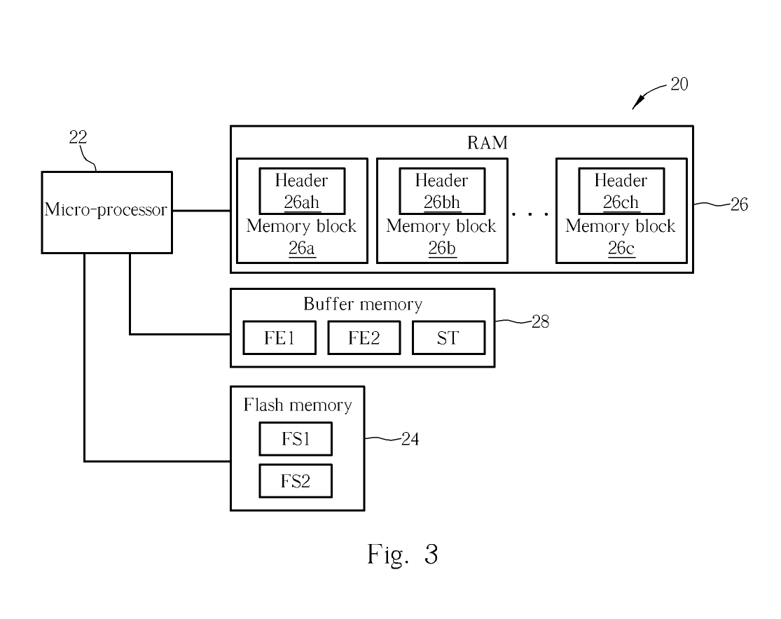

Please refer to FIG. 3. FIG. 3 is a functional block diagram of a computer system 20 according to the present invention. The computer system 20 comprises a microprocessor 22, a flash memory 24, a random access memory (RAM) 26, and a buffer memory 28. In the present embodiment, a source code FS1 of a first function F1 and a source code FS2 of a second function F2 are stored in the flash memory 24. The RAM 26 contains a plurality of memory blocks 26a, 26b, and 26c. The memory blocks 26a, 26b, 26c have corresponding headers 26ah, 26bh, 26ch, respectively. It should be noted that the components of the computer system 20 and the components with the same names of the computer system 10 shown in FIG. 1 have similar functions, so the functions and operations of these components are not repeatedly described. In the present embodiment, in addition to the first function execution code FE1 generated by the microprocessor 22 compiling the first function F1 and the second function execution code FE2 generated by the microprocessor 22 compiling the second function F2, the buffer memory 28 further stores a symbol mapping table ST. The symbol mapping table ST stores the function name (i.e., F1) of the first function F1, and a symbol address F1A corresponding to the first function execution code FE1. The first function execution code FE1 is stored in the buffer memory 28 at the address F1A. Similarly, the symbol mapping table ST also stores the function name (i.e., F2) of the second function F2, and a symbol address F2A corresponding to the second function execution code FE2. The second function execution code FE2 is stored in the buffer memory 28 at the address F2A. The purpose of the symbol mapping table ST in the present embodiment will be described in the following paragraph. Please note that the symbol mapping table ST is a necessary component required during the compilation process according to the present invention. Please note that the detailed process of how the symbol mapping table ST is built is not a limitation of the present invention.

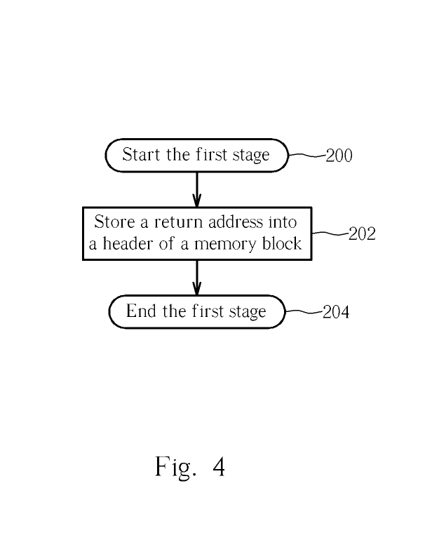

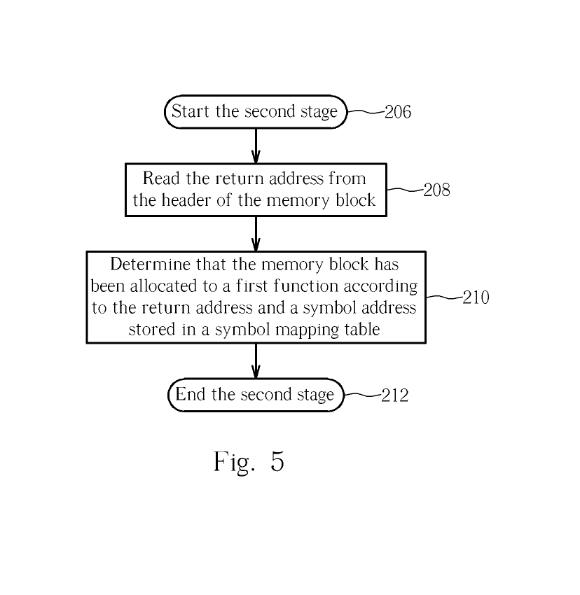

Please refer to FIG. 3, FIG. 4 and FIG. 5. FIG. 4 is a flowchart of a first stage of a searching method that determines a function associated with the memory block 16b. FIG. 5 is a flowchart of a second stage of the searching method that determines a function associated with the memory block 16b. The searching method according to the present invention comprises two stages that are referred to as the first stage and the second stage.

The first stage comprises the following steps:

Step 200: Start the first stage.

Step 202: Store the return address RA into the header 26bh of the memory block 26b.

Step 204: End the first stage.

When an engineer (e.g., a programmer) discovers that there may be a memory leak, he controls the computer system 20 to start executing the second stage.

The second stage comprises the following steps:

Step 206: Start the second stage.

Step 208: Read the return address RA from the header 26bh of the memory block 26b.

Step 210: Determine that the memory block 16b has been allocated to the first function F1 during the execution time of the first function execution code FE1 according to the return address RA and the symbol address F1A stored in the symbol mapping table ST.

Step 212: End the second stage.

The detailed description of the above-mentioned first stage, as shown in FIG. 4, is included in the following paragraph. For example, some space of the buffer memory 28 is utilized for storing the first function execution code FE1 corresponding to the first function F1. The execution code of the line number L1 is stored in the buffer memory 28 at an address A1, and the execution code of the line number L2 is stored in the buffer memory 28 at an address A2. The second function execution code FE2 corresponding to the second function F2 is stored in the buffer memory 28 at an address B1.

In the present embodiment, when a program is being executed, if the computer system 20 starts to execute the first function execution code FE1, specifically, FE1's certain part that is corresponding to the line number L1. In other words, the computer system 20 starts to execute the execution code data stored in the buffer memory 28 at the address A1. The first function F1 must call the second function F2. At this time the computer system 20 performs two steps at the same time. The two steps comprises: (1) the execution point branching to the address B1, and (2) viewing the address A2 as the return address RA of the second function F2 (the second function execution code FE2) and recording the address A2 in a return address register (i.e., a LR Register). The computer system 20 then stores the return address RA (that is address A2 currently) stored in the return address register into the header 26bh of the memory block 26b (Step 202). Please note that in other embodiments of the present invention, the return address RA can be recorded in a stack, not in a return address register. In addition, the stack can be stored in the buffer memory 28 or any other memory devices that can be accessed by the microprocessor 22. Next, the computer system 20 starts to execute the data stored in the buffer memory 28 at the address B1; that is, the computer system 20 starts to execute the second function execution code FE2. After the execution of the second function execution code FE2 is finished, the execution point will branch back to the address A2 recorded in the return address register, and the computer system 20 then executes the line number L2 of the first function F1 (the line next to and following the line L1), which means the computer system 20 executes the first function execution code FE1's certain part corresponding to the line number L2. Please note that the return address RA is dynamically obtained during the program execution time. In this way, the present invention does not need to occupy any space of the buffer memory 28 to store the additional data according to the prior art, comprising the pre-process directives _{——}FILE_{——} and _{——}LINE_{——} shown in FIG. 1. The method according to the present invention can reduce the load of the computer system 20.

When an engineer (i.e., a programmer) discovers that there may be a memory leak, the engineer needs to look up all headers of all the memory blocks to find an abnormal operated allocated memory block. The abnormal operated allocated memory block is a memory block that should be returned to the computer system 20 but still has not been returned. In the present embodiment, assume the memory block 26b is the above-mentioned abnormally operated allocated memory block. The engineer can read the return address RA from the header 26bh of the memory block 26b (step 208). However, at this time, the engineer does not know that the memory block 26b is/has been allocated to which function by the computer system 20. The engineer selects a greatest value (number) from all numbers that are stored in the symbol mapping table ST and smaller than the return address RA. The greatest value (number) corresponds to the symbol address F1A. In this way, it can be known that the memory block 26b storing the return address RA has been allocated by the computer system 20 to the first function F1 corresponding to the symbol address F1A (step 210).

In the above-mentioned embodiment, the present invention method is applied to the problems associated with memory leaks. However, the present invention method can also be utilized for recording a call stack or be applied on a system security design. Additionally, some other applications, like setting certain open functions to only allow certain modules to call, are covered by the present invention.

In contrast to the prior art, the searching method according to the present invention is that there is definitely no need to occupy any additional non-volatile memory space. Also, in contrast to the prior art memory allocation information, the present invention memory allocation information stored in a header of an allocated memory block is only a return address, and it only requires 4 bytes of space in the header to store the return address. In this way, it is easy to precisely and quickly find a function associated with the allocated memory block. Hence, the present invention searching method generates less system overhead for the computer system. Additionally, the present invention reduces the expended time and memory space to further increase the execution performance and speed up the execution of the computer system.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A searching method for determining a function associated with a memory block of a memory of a computer system function; the memory comprising a plurality of memory blocks and storing a first function execution code, a second function execution code, and a symbol mapping table; the first function execution code executed by the computer system calling a second function execution code to require the computer system to allocate a first memory block to the first function execution code; the symbol mapping table storing a symbol address corresponding to the first function execution code; the searching method comprising:
(a) storing a return address of the second function execution code into a predetermined memory block of the memory; and
(b) reading the return address from the predetermined memory block, and determining that the first memory block has been allocated to the first function execution code according to the return address and the symbol address stored in the symbol mapping table.

2. The searching method of claim 1, wherein the predetermined memory block is the first memory block.

3. The searching method of claim 2, wherein step (a) further comprises storing the return address into a header of the first memory block.

4. The searching method of claim 1, wherein the symbol mapping table stores the function name and the symbol address of the first function execution code, and the symbol address is an address at which the function name is stored in the memory.

5. A computer system, comprising:
a memory comprising a plurality of memory blocks for storing a first function execution code, a second function execution code, and a symbol mapping table, wherein the symbol mapping table stores a symbol address corresponding to the first function execution code; and
a computation unit, coupled to the memory, for executing the first function execution code and the second function execution code, wherein the first function execution code calls the second function execution code to require the computer system to allocate a first memory block to the first function execution code and stores a return address of the second function execution code into a predetermined memory block of the memory, and the computation unit reads the return address from the predetermined memory block and determines that the first memory block has been allocated to the first function execution code according to the return address and the symbol address stored in the symbol mapping table.

6. The computer system of claim 5, wherein the predetermined memory block is the first memory block.

7. The computer system of claim 6, wherein the computation unit stores the return address into a header of the first memory block.

8. The computer system of claim 5, wherein the symbol mapping table stores the function name and the symbol address of the first function execution code, and the symbol address is an address at which the function name is stored in the memory.
